(19) United States
(12) Patent Application Publication
(10) Pub. No.: US 2025/0245059 A1
(43) Pub. Date: Jul. 31, 2025

(54) MANAGING SYSTEM DATA USING OUT-OF-BAND METHODS

(71) Applicant: Dell Products L.P., Round Rock, TX (US)

(72) Inventors: RAJARAVI CHANDRA KOLLARAPU, Allen, TX (US); VINODKUMAR VASUDEV OTTAR, Mckinney, TX (US); ADOLFO SANDOR MONTERO, Pflugerville, TX (US); RICHARD M. TONRY, Georgetown, TX (US); ABEYE TESHOME, Austin, TX (US); LUIS ANTONIO VALENCIA REYES, Waxahachie, TX (US); BASSEM EL-AZZAMI, Austin, TX (US); MOHIT ARORA, Frisco, TX (US)

(21) Appl. No.: 18/425,220

(22) Filed: Jan. 29, 2024

(51) Int. Cl. G06F 9/50; H04L 9/08

(52) U.S. Cl. CPC G06F 9/5044; H04L 9/088; H04L 9/0894

(57) ABSTRACT

Methods and systems for managing a data processing system are disclosed. The data processing system may experience an occurrence of a hardware event that may impair operation of hardware resources of the data processing system. When the occurrence of the hardware event is identified, the data processing system may undergo a reprovisioning process via an out-of-band channel established with a remote system. Once reprovisioned, a management controller of the data processing system may obtain system data usable to manage the hardware event from the remote server. An update process for the data processing system may be performed using the system data in order to mitigate the impairment of the operation of the hardware resources (e.g., to obtain updated hardware resources). A computer-implemented service may be provided using the updated hardware resources.

### FIELD

Embodiments disclosed herein relate generally to managing data processing systems. More particularly, embodiments disclosed herein relate to systems and methods for managing system data of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIG. 1C shows a block diagram illustrating moving of a data processing system through a stream of commerce in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a data processing system. The data processing system may provide computer-implemented services. The computer-implemented services may be provided as a result of expected operation of hardware resources of the data processing system. To operate in the expected manner, the hardware resources (e.g., and/or software applications hosted by the hardware resources) may rely on access to usable system data. The system data may include, for example, secrets (e.g., encryption data), certificates, vouchers, configuration data, and/or other data necessary to provide the computer-implemented services.

However, the data processing system may be subject to hardware events that may negatively affect access to the usable system data, which may impair the operation of the hardware resources. For example, the system data may be lost or may become inaccessible (e.g., if components used to store or facilitate access to the system data are removed from the data processing system) and/or may become unusable (e.g., encryption keys may expire over time). The hardware event may, for example, cause the system data to become locally unrecoverable; therefore, to mitigate the impaired operation of the hardware resources (and to avoid disruptions to the provision of the computer-implemented services), the system data may be recovered from a remote system.

To recover the system data, the data processing system may include and rely on hardware resources (e.g., in-band components of the data processing system) to perform actions to request and/or obtain the system data from the remote system. However, if the operation of the in-band components is impaired (e.g., the in-band components may be inoperable due to the hardware event and/or due to being unpowered), then the in-band components may not be reliable to perform the actions.

Thus, the impaired operation of the hardware resources may be mitigated using out-of-band methods. To do so, the data processing system may include out-of-band components and out-of-band (communication) channels that function independently from the in-band components. The out-of-band components (e.g., a management controller) of the data processing system may communicate with a remote management system (e.g., the remote system) in order to reprovision the data processing system and/or to recover the system data. Consequently, if the in-band components and/or communication channels are compromised or non-operational, then the out-of-band components and communication channels may remain available, uncompromised, and reliable to perform actions necessary to recover the system data.

By doing so, embodiments disclosed herein may provide a system for managing system data recovery after occurrence of a hardware event. The out-of-band components may use the system data to initiate and/or manage a system update process for the data processing system, despite likely unavailable in-band components of the data processing system.

In an embodiment, a computer-implemented method for managing a data processing system is provided. The method may include making, by a management controller of the data processing system, an identification of an occurrence of a hardware event for the data processing system that impairs operation of hardware resources of the data processing system.

The method may also include, based on the identification: providing, by the management controller and via an out-of-band channel and to a remote system, a request for reprovisioning of the data processing system; and, obtaining, by the management controller and via the out-of-band channel and from the remote system, a response to the request for reprovisioning.

The method may also include, based on the response to the request for reprovisioning: obtaining, by the management controller and via the out-of-band channel and from the remote system, system data for the data processing system, the system data being usable to manage the hardware event; performing, by the data processing system, an update process using the system data in order to mitigate the impairment of the operation of the hardware resources to obtain updated hardware resources; and, providing, by the data processing system, a computer-implemented service using the updated hardware resources.

The hardware event may include modification of a component of the hardware resources. The modification may cause an encryption key previously stored by the data processing system to become unusable by the data processing system.

The request for reprovisioning may include an identifier for the component of the hardware resources, the component having been replaced as a first part of the hardware event and the replacement of the component causing the hardware resources to differ from that expected by the remote system. The reprovisioning may include registering the data processing system using the identifier for the component, and an updated ownership voucher established with the remote system as a second part of the hardware event.

The system data may include the encryption key.

Performing the update process may include providing, by the management controller and via a sideband channel, the encryption key for storage in a trusted platform module of the data processing system. Performing the update process may further include providing, by the management controller and via the out-of-band channel and to the remote system, a notification indicating an outcome of the update process.

The data processing system may include a network module adapted to separately advertise network endpoints for the management controller and the hardware resources, the network endpoints being usable by remote systems to address communications to the hardware resources and the management controller.

The out-of-band channel may run through the network module and an in-band channel that services the hardware resources may also run through the network module.

The management controller and the network module may be on separate power domains from the hardware resources so that the management controller and the network module are operable while the hardware resources are inoperable. The occurrence of the hardware event may be managed while the hardware resources are inoperable due to being unpowered.

A non-transitory media may include instructions that when executed by a processor cause the computer-implemented method to be performed.

The data processing system may include the non-transitory media and a processor, and may perform the computer-implemented method when the computer instructions are executed by the processor.

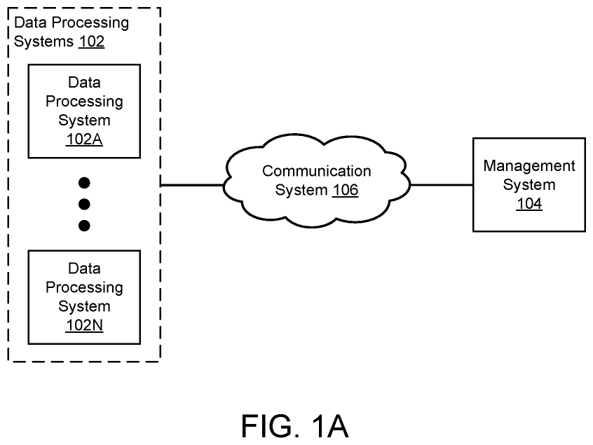

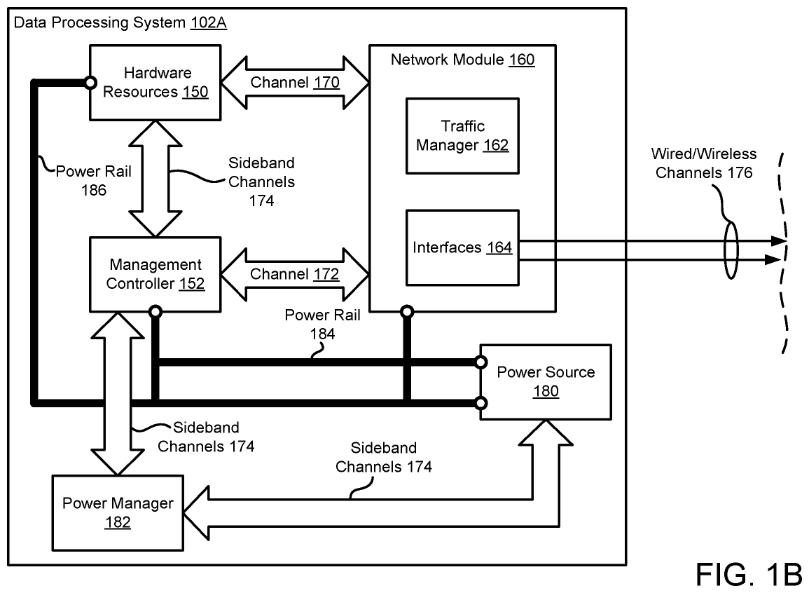

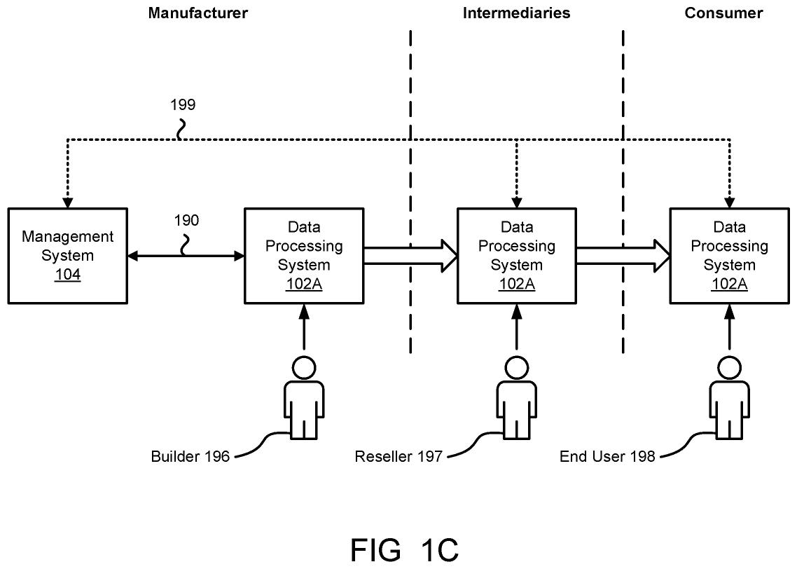

Turning to FIG. 1A, a block diagram illustrating a distributed system in accordance with an embodiment is shown. The (distributed) system shown in FIG. 1A may provide computer-implemented services. The computer-implemented services may include any type and quantity of services including, for example, data services (e.g., data storage, access and/or control services), communication services (e.g., instant messaging services, video-conferencing services), and/or any other type of service that may be implemented with a computing device.

The computer-implemented services may be provided by one or more components of the system of FIG. 1A. The computer-implemented services may be provided by, for example, data processing systems 102, management system 104, and/or any other type of devices (not shown in FIG. 1A). The system may include any number of data processing systems 102 (e.g., computing devices) that may each include any number of hardware components (e.g., processors, memory modules, storage devices, communications devices). The hardware components may support execution of any number and types of applications (e.g., software components).

For example, a data processing system (e.g., 102A) may include hardware resources that, when operated in an expected manner, provide at least a portion of the computer-implemented services. To operate in the expected manner, the data processing system may rely on system data (e.g., configuration data, encryption keys, certificates) stored thereon. For example, cryptographic data stored by a trusted platform module (TPM) of the data processing system may be used to encrypt or decrypt data, to initiate (e.g., validate) processes (e.g., software applications), for establishing connections with remote systems, etc. Without access to usable system data, operation of the hardware resources may be impaired, which may cause interruptions to the computer-implemented services.

For example, the operation of the hardware resources may be impaired due to an occurrence of a hardware event. The hardware event may include a modification of a component (e.g., a hardware component) of the hardware resources and/or any event that may cause the system data to become unusable by the data processing system. For example, replacement of a component of the hardware resources may cause an encryption key previously stored by the data processing system to become lost or inaccessible by the data processing system and/or an expired encryption key may be unusable by the data processing system.

Thus, to avoid lengthy disruptions to the provision of the computer-implemented services by the data processing system, the system data may be restored. However, to restore the system data, the data processing system may rely on the hardware resources operating in the expected manner (e.g., to host an application that may obtain and/or store the system data securely). To restore the expected operation of the hardware resources, a management entity (e.g., an operating system) and/or other software applications of the data processing system may need to be re-installed, which may be time-consuming and may require manual efforts. Therefore, to manage the hardware event in a timely, secure, and efficient manner, the system data may be restored to the data processing system using out-of-band methods that do not rely on potentially operationally impaired hardware resources.

In general, embodiments disclosed herein may provide methods, systems, and/or devices for managing system data for a data processing system using out-of-band methods. To implement the out-of-band methods, the data processing system may include out-of-band components (e.g., a management controller) that may communicate with remote systems over secure out-of-band channels without traversing in-band channels and without utilizing in-band components (e.g., hardware resources) of the data processing system. For example, after identifying an occurrence of a hardware event (e.g., that impairs the hardware resources), the remote systems may push system data to the out-of-band components independently from the impaired in-band components and in-band channels. The out-of-band components may use the system data to restore the expected operation of the hardware resources. By doing so, manual efforts may be reduced, and inoperable in-band components and potentially unsecure in-band channels may be circumvented, increasing the likelihood of effectively managing impacts of the hardware event for the data processing system.

To perform the above-mentioned functionality, the system of FIG. 1A may include data processing systems 102 and/or management system 104. Data processing systems 102, management system 104, and/or any other type of devices not shown in FIG. 1A may perform all, or a portion of the computer-implemented services independently and/or cooperatively. Each of these components is discussed below.

Data processing systems 102 may include any number and/or type of data processing systems (e.g., 102A-102N). Any of data processing systems 102 may include in-band components (e.g., hardware resources) and out-of-band components (e.g., a management controller, a network module, etc.), and functionality that may allow the out-of-band components to interact with remote systems independently from the in-band components. For more information regarding out-of-band components of data processing systems 102, refer to the discussion of FIG. 1B.

To manage hardware events, for example, out-of-band components such as a management controller of a data processing system (e.g., 102A) may (i) make an identification of a hardware event for the data processing system (e.g., a modification of a component of the hardware resources of the data processing system) and based on the identification, (ii) request reprovisioning of the data processing system from remote systems (e.g., via out-of-band channels established between the management controller and a remote systems), (iii) request and/or obtain data (e.g., system data, via the out-of-band channels), (iv) initiate and/or perform update processes for the data processing system (e.g., using the system data, via the sideband channel) to mitigate an impairment of the operation of the hardware resources indicated by the hardware event, and/or (v) perform other actions (e.g., that may relate to facilitating the data processing system providing computer-implemented services).

In-band components (e.g., hardware resources) of the data processing system may, for example, (i) exchange data with the out-of-band components (e.g., while being managed by the management controller, via the sideband channel), (ii) participate in update processes for the data processing system (e.g., in conjunction with the management controller), and/or (iii) perform other actions (e.g., provide computer-implemented services).

Management system 104 may include any number and/or type of systems and may be implemented using any number of physical devices including an internet of things (IOT) hub. The IoT hub may include a message broker service that directs communications between the components of FIG. 1A and/or IoT devices that may provide computer-implemented services (e.g., Cloud-based services). For example, the IoT hub may be responsible for providing communications from a management controller of data processing system 102A to a remote system of management system 104 that may provide a specific service to data processing system 102A.

For example, management system 104 may provide data services, provisioning (e.g., reprovisioning) services, and/or other services (e.g., ownership management services, data generation services) for data processing systems 102. To provide services, management system 104 may communicate with data processing systems 102 and/or other devices not shown in FIG. 1A. The communication channels established between management system 104 and data processing systems 102 may, for example, include out-of-band channels. The out-of-band channels may be more secure and/or reliable than potentially compromised and/or unavailable in-band channels of data processing systems 102.

To provide its functionality, management system 104 may (i) manage backup data for data processing systems 102 (e.g., obtain backups for critical data stored on data processing systems 102, such as system data), (ii) manage ownership vouchers for data processing systems 102 (e.g., allow for updates to the ownership vouchers by authorized users), (iii) receive and/or respond to requests for reprovisioning of data processing systems 102, (iv) obtain new data for data processing systems 102 (e.g., facilitate encryption key pair generation), (v) receive and/or respond to requests for data retrieval (e.g., backed up system data such as encryption keys) for data processing systems 102, and/or (vi) perform other actions (e.g., obtain notifications indicating the system status of data processing systems 102).

Data backups for data processing systems 102 may be performed by management system 104 at different phases of the lifecycle of data processing systems 102. Refer to the discussion of FIG. 1C for information regarding data backup for data processing systems 102.

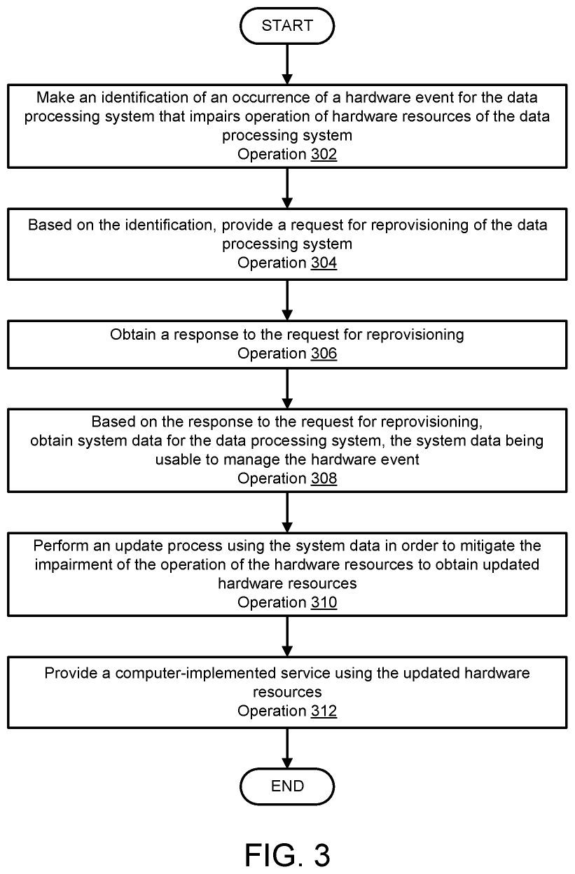

When providing their functionality, any of data processing systems 102 and/or management system 104 may perform all, or a portion of the method shown in FIG. 3.

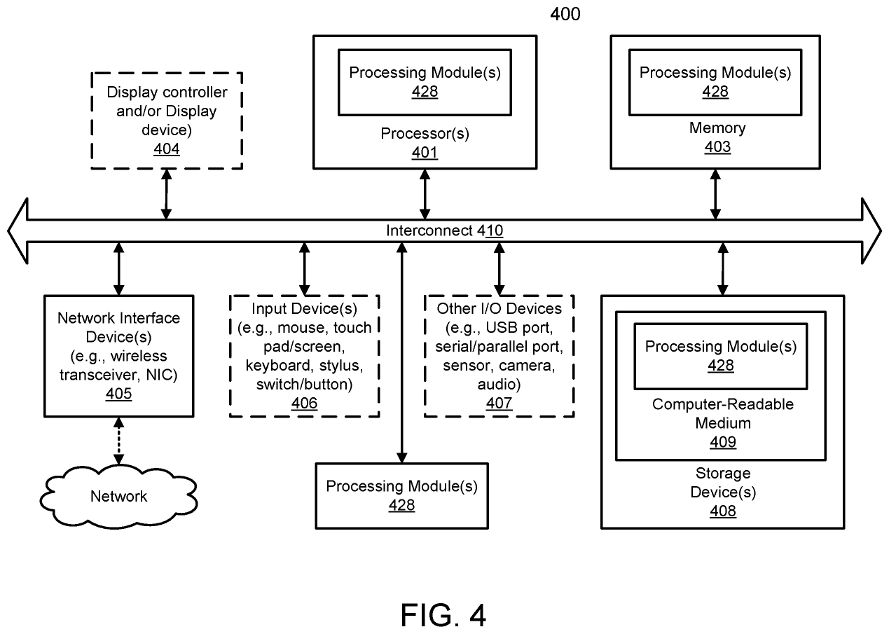

Any of (and/or components thereof) data processing systems 102, and/or management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

In an embodiment, one or more of data processing systems 102 and/or management system 104 are implemented using an IoT device, which may include a computing device. The IoT device may operate in accordance with a communication model and/or management model known to data processing systems 102, management system 104, and/or other devices.

Any of the components illustrated in FIG. 1A may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and/or types of communication protocols (e.g., such as the internet protocol).

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102A shown in FIG. 1B may be similar to any of the computing devices shown in FIG. 1A (e.g., one of data processing systems 102).

To provide computer-implemented services, data processing system 102A may include any quantity of hardware resources 150. Hardware resources 150 may be in-band hardware components, and may include a processor operably coupled to memory, storage, and/or other hardware components.

Data processing system 102A may include a trusted platform module (TPM). The TPM (not shown) may be included as a portion of hardware resources 150 and/or may operate independently from hardware resources 150. For example, the TPM may be implemented using a system on a chip or other type of independently operating computing device. The TPM may store and/or manage access to secrets (e.g., encryption keys) usable by data processing system 102A in order to provide computer-implemented services. The TPM may include functionality for performing cryptographic operations for data processing system 102A including, for example, generation and/or maintenance of encryption key pairs (e.g., public private key pairs, random number generation, hash generation, and/or other functionalities.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102A) to another device via any number of intermediate networks (e.g., via wired/wireless channels 176 that are part of the networks).

To reduce the likelihood of the applications and/or other in-band entities from being indirectly compromised, data processing system 102A may include management controller 152 and network module 160. Each of these components of data processing system 102A is discussed below.

Management controller 152 may be implemented, for example, using a system on a chip or other type of independently operating computing device (e.g., independent from the in-band components, such as hardware resources 150 of a host data processing system 102A). Management controller 152 may provide various management functionalities for data processing system 102A. Management controller 152 may, for example, monitor various ongoing processes performed by the in-band components, may manage power distribution, thermal management, and/or may perform other functions for managing data processing system 102A. For example, management controller 152 may monitor various ongoing processes to identify a hardware event for data processing system 102A, and in response, may also manage power distribution to manage the hardware event.

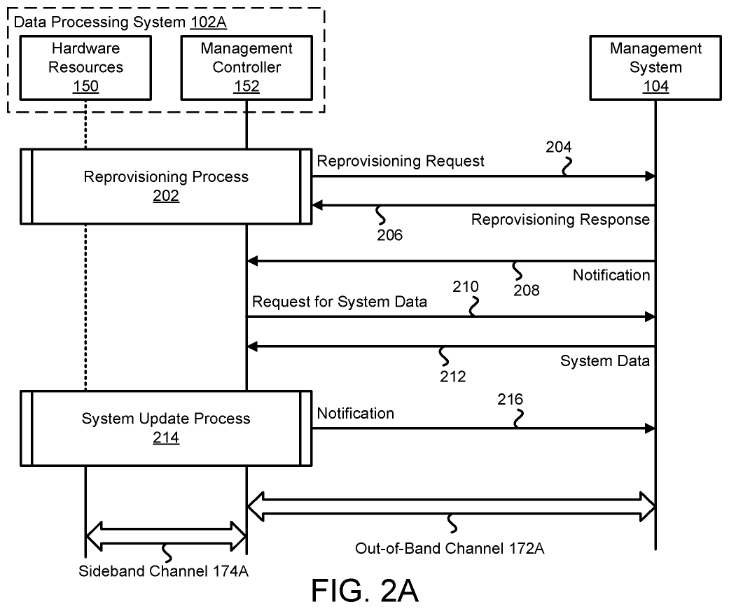

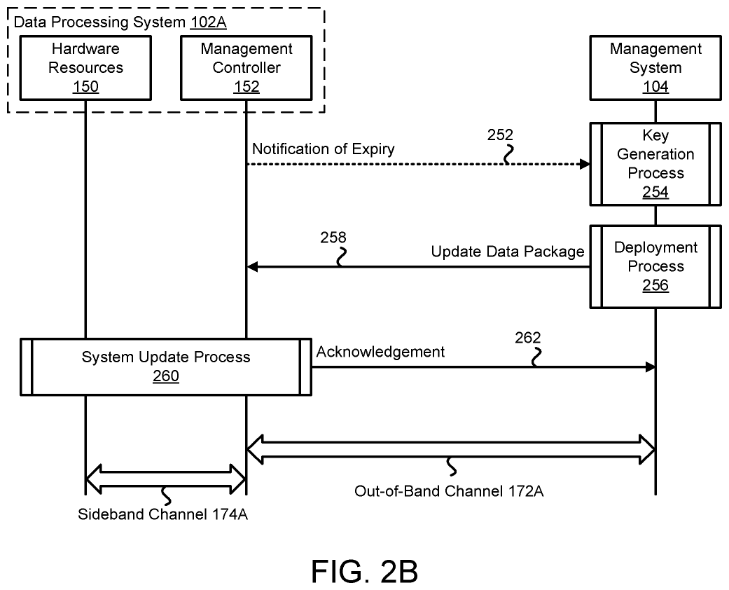

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels such as 174A shown in FIGS. 2A-2B). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 102A via separate channels (e.g., 172, 172A shown in FIGS. 2A-2B) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

To facilitate communication with other devices, data processing system 102A may include network module 160. Network module 160 may provide communication services for in-band components and out-of-band components (e.g., management controller 152) of data processing system 102A. To do so, network module 160 may include traffic manager 162, and interfaces 164.

Traffic manager 162 may include functionality to (i) discriminate traffic directed to various network endpoints advertised by data processing system 102A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

For example, during communications with a remote system (e.g., management system 104), messages from the remote system may be addressed to a network endpoint advertised by network module 160 for out-of-band communications. The message may include information needed to manage occurrences of hardware events for data processing system 102A, such as system data for data processing system 102A. Once the message is received by traffic manager 162, traffic manager 162 may forward the message to management controller 152 via an out-of-band communication channel (e.g., channel 172), differentiating the message from in-band communications to data processing system 102A. The message obtained by data processing system 102A using out-of-band methods may be more likely to be obtained by data processing system 102A than when using in-band methods that may be unavailable due to the hardware event.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These component may support any number of wired/wireless channels 176.

Thus, from the perspective of an external device, the in-band components and out-of-band components of data processing system 102A may appear to be two independent network entities that may be independently addressable and/or otherwise unrelated to one another.

To facilitate management of data processing system 102A over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 is unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

Therefore, if operation of hardware resources 150 is impaired (e.g., due to an occurrence of a hardware event) then out-of-band components may remain powered in order to manage impacts of the hardware event. For example, management controller 152 may communicate with remote devices (e.g., management system 104) in order to obtain information usable to manage the hardware event, authenticate the information, and/or initiate system update processes using the information.

To implement the separate power domains, data processing system 102A may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, supplied via the power rails (e.g., by providing instructions via sideband channels 174). Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

Turning to FIG. 1C, a diagram illustrating a process through which a management system may provide services for a data processing system in accordance with an embodiment is shown. In FIG. 1C, a selection of some different phases of the lifecycle of data processing system 102A are shown.

The lifecycle of data processing system 102A may start with a manufacturer. While with the manufacturer, a builder (e.g., builder 196) may add hardware components to data processing system 102A to complete the hardware resources.

When so completed, an integrity management system (e.g., management system 104) may (i) identify the hardware components of the hardware resources (e.g., via operable connection 190) and/or (ii) obtain backup data for data processing system 102A (e.g., system data including secrets of data processing system 102A).

Using the identified hardware components, an ownership voucher may be obtained. Information included in ownership voucher may be usable to identify components of hardware resources present at a past point in time (e.g., at the time of manufacturing of data processing system 102A). The information may include, for example, (i) a list of identifiers, (ii) signatures (e.g., hashes of firmware code or other readable data), and/or (iii) other information that allows any component of data processing system 102A to be validated as being expected or unexpected. The ownership voucher may include a signed data structure (e.g., a certificate) usable to discriminate expected from unexpected components of data processing system 102A. The ownership voucher may be stored by management system 104 and/or by other devices (e.g., a management controller of data processing system 102A).

The backup data for data processing system 102A may be stored in a backup database (not shown) managed by management system 104 to facilitate recovery of the backup data when warranted. For example, if a component of data processing system 102A is modified (e.g., replaced, while undergoing servicing), portions of data stored by data processing system 102A (e.g., the backup data) may become unavailable to and/or unusable by data processing system 102A. Thus, the backup data (e.g., critical data such as encryption keys, certificates, configuration data) may be backed up to avoid data loss due to periodic authorized servicing of data processing system 102A. Data stored by data processing system 102A may be backed up throughout the lifecycle of data processing system 102A (e.g., via operable connection 199).

Once manufactured, data processing system 102A may be placed into the stream of commerce. For example, data processing system 102A may be sold to various intermediaries at which point a reseller (e.g., reseller 197) may have physical access to data processing system 102A. Any number of intermediaries may be in the stream of commerce until data processing system 102A reaches a consumer (e.g., end user 198). The consumer may be an individual or an organization.

Once there, an end user (e.g., end user 198) may have physical access to data processing system 102A. Data processing system 102A may be accessed (e.g., operated, by end user 198).

Because reseller 197, end user 198, and/or other persons may have physical access to data processing system 102A, any hardware components may be modified (e.g., replaced, removed, and/or new components may be added). These changes in the hardware components may be unexpected with respect to the ownership voucher.

Over time, a modification to a portion of the hardware components of data processing system 102A may be warranted in order to provide desired computer-implemented services; therefore, the modification may be authorized (e.g., by a management entity of data processing system 102A). In cases where the modification is authorized, the ownership voucher may be updated (e.g., by a service technician with authority to do so). For example, the list of identifiers of the ownership voucher may be updated to reflect the modified portion of the hardware components. By doing so, the updated ownership voucher may be used to validate (or invalidate) a hardware loadout of data processing system 102A after occurrence of a hardware event (e.g., during a reprovisioning process and/or during a startup process for data processing system 102A).

To further clarify embodiments disclosed herein, interaction diagrams in accordance with an embodiment are shown in FIGS. 2A-2B. The interaction diagrams may illustrate examples of how data may be obtained and used within the systems of FIGS. 1A-1B.

In the interaction diagrams, processes performed by and interactions between components of a system in accordance with an embodiment are shown. In the diagram, components of the system are illustrated using a first set of shapes (e.g., 150, 152, etc.), located towards the top of each figure. Lines descend from these shapes. Processes performed by the components of the system are illustrated using a second set of shapes (e.g., 202, 214 etc.) superimposed over these lines. A portion of the line descending from hardware resources 150 is drawn in dashing to indicate that hardware resources 150 may be unavailable (e.g., operation of hardware resources 150 may be impaired).

Interactions (e.g., communication, data transmissions, etc.) between the components of the system are illustrated using a third set of shapes (e.g., 204, 206, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur. Lines are drawn in dashing (e.g., between management controller 152 and management system 104) to indicate that the interactions are optional and/or may depend on policies of data processing system 102A.

Generally, the processes and interactions are temporally ordered in an example order, with time increasing from the top to the bottom of each page. For example, the interaction labeled as 204 may occur prior to the interaction labeled as 206. However, it will be appreciated that the processes and interactions may be performed in different orders, any may be omitted, and other processes or interactions may be performed without departing from embodiments disclosed herein.

The processes shown in FIGS. 2A-2B may be performed by any entity shown in the systems of FIGS. 1A-1B (e.g., a device similar to one of data processing systems 102, systems similar to management system 104, etc.) and/or another entity without departing from embodiments disclosed herein.

Turning to FIG. 2A, a first interaction diagram in accordance with an embodiment is shown. The first interaction diagram may illustrate processes and interactions that may occur when recovering system data of a data processing system. As discussed with respect to FIGS. 1A-1B, data processing system 102A may include hardware resources 150 and management controller 152. Data processing system 102A may rely on operation of hardware resources 150 in order to provide a computer-implemented service. However, data processing system 102A may experience a hardware event that may impair the operation of hardware resources 150, interrupting the computer-implemented service.

Over time, a portion of components of hardware resources 150 may fail and/or may warrant modification for other reasons, which may lead to an occurrence of a hardware event for data processing system 102A. For example, the hardware event may include a service technician replacing a component of hardware resources 150. The replacement may cause secrets (e.g., encryption keys or other data) previously stored by and/or accessible via the component to be lost (or become inaccessible). In addition, the replacement of the component may cause impaired operation of hardware resources 150 (e.g., data processing system 102A may be unable to complete a startup process due to the hardware event, leaving hardware resources 150 inoperable). The operational impairment of hardware resources 150 is indicated by the dashed line descending from hardware resources 150.

The replacement of the component may cause a hardware loadout of hardware resources 150 to differ from an expected hardware loadout (e.g., recorded in an ownership voucher of data processing system 102A, managed by management system 104). Therefore, the hardware event may include updating (e.g., by the service technician or another management entity) the ownership voucher to reflect the replaced component. For example, the ownership voucher may be updated by the service technician via a device that hosts an application of management system 104 usable to do so.

As management controller 152 may remain operable despite impaired operation of hardware resources 150, management controller 152 may make an identification of the occurrence of the hardware event. For example, the service technician may log into management controller 152 via out-of-band methods using a service device, placing the service technician in control of management controller 152. Alternatively, management controller 152 may make the identification based on a hardware loadout difference (e.g., using the ownership voucher locally accessible to management controller 152 during startup of data processing system 102A). Management controller 152 may be prompted (e.g., by instructions obtained from the service technician and/or in response to the hardware loadout difference) to initiate a reprovisioning process for data processing system 102A in order to manage the hardware event.

Management controller 152 may manage the hardware event (e.g., initiate and/or perform reprovisioning process 202) while hardware resources 150 are inoperable and/or unpowered. Reprovisioning process 202 may be initiated and/or performed automatically based on the identification of the hardware event and/or for other reasons. Reprovisioning process 202 may include obtaining (e.g., generating) a reprovisioning request for data processing system 102A. The reprovisioning request may include, for example, (i) a message indicating that an occurrence of a hardware event has been identified, (ii) a hardware loadout (e.g., identifiers for components of hardware resources 150, including an identifier for the modified component), (ii) a device identifier for data processing system 102A and/or management controller 152, and/or (iii) other data (e.g., authentication information, information regarding the hardware event, etc.). The identifier for the modified component may include, for example, a serial number of the modified component assigned by a manufacturer of the modified component.

At interaction 204, the reprovisioning request may be provided to management system 104 (e.g., via an IoT hub) by management controller 152. For example, the reprovisioning request may be generated by management controller 152 and may be provided to management system 104 via out-of-band channel 172A through (i) transmission via a message, (ii) storing in a storage with subsequent retrieval by management system 104, (iii) a publish-subscribe system where management system 104 subscribes to updates from management controller 152 thereby causing a copy of the reprovisioning request to be propagated to management system 104, and/or (iv) other processes. By providing the reprovisioning request to management system 104, management system 104 may provide services (e.g., reprovisioning services) for data processing system 102A.

Using information included in the reprovisioning request, management system 104 may (i) perform authentication processes for data processing system 102A and/or the reprovisioning request, (ii) identify an (updated) ownership voucher for data processing system 102A, (iii) validate the hardware loadout provided by management controller 152, and/or (iv) perform other actions (e.g., according to policies for data processing system 102A). Based on its ability to authenticate data processing system 102A, management system 104 may re-establish data processing system 102A as a trusted device.

For example, management system 104 may validate the hardware loadout by comparing a list of identifiers of the hardware loadout with a list of identifiers of the (updated) ownership voucher. The updated ownership voucher may have been previously generated (e.g., by the service technician) following replacement of the hardware component and may indicate that the replaced hardware component is expected. If the lists match, then management system 104 may register (e.g., re-register) data processing system 102A as a trusted device. Registering data processing system 102A may include adding data processing system 102A to a list of trusted devices maintained by management system 104, removing data processing system 102A from a list of potentially compromised devices, and/or other actions to signal successful remediation of the hardware event. By completing registration for data processing system 102, data processing system 102 may be trusted to obtain services from other service systems of management system 104.

Management system 104 may respond to the provisioning request by obtaining (e.g., generating) a reprovisioning response. The reprovisioning response may include a (signed) data package. For example, the reprovisioning response may include an acknowledgement that management system 104 has established trust with data processing system 102A, a copy of the updated ownership voucher, and/or other provisioning data (e.g., signed data structures).

At interaction 206, the reprovisioning response may be provided to management controller 152 by management system 104. For example, the reprovisioning response may be provided to management controller 152 via out-of-band channel 172A through (i) transmission via a message, (ii) storing in a storage with subsequent retrieval by management controller 152, (iii) a publish-subscribe system where management controller 152 subscribes to updates from management system 104 thereby causing a copy of the reprovisioning response to be propagated to management controller 152, and/or (iv) other processes.

Upon obtaining the reprovisioning response, management controller 152 may perform actions to complete reprovisioning process 202. For example, management controller 152 may authenticate management system 104 and/or may store data included in the reprovisioning response (e.g., the copy of the updated ownership voucher) in various storage locations of data processing system 102A (e.g., via communications with portions of hardware resources 150 across sideband channel 174A).

Upon establishing data processing system 102A as a trusted device, management system 104 may generate and/or provide a notification to management controller 152. The notification may include (i) a message indicating that system data (e.g., certificates, encryption keys, configuration data) for data processing system 102A is available and/or (ii) a portion of the system data available to data processing system 102A.

At interaction 208, the notification may be provided to management controller 152 by management system 104. For example, the notification may be provided to management controller 152 via out-of-band channel 172A through (i) transmission via a message, (ii) storing in a storage with subsequent retrieval by management controller 152, (iii) a publish-subscribe system where management controller 152 subscribes to updates from management system 104 thereby causing a copy of the notification to be propagated to management controller 152, and/or (iv) other processes.

Management controller 152 may obtain and/or read the notification. The notification may prompt management controller 152 to obtain (e.g., generate) a request for at least a portion of the available system data. The request for system data may include device identifiers, authentication information, etc.

At interaction 210, the request for system data may be provided to management system 104 (e.g., via an IoT hub) by management controller 152. For example, the request for system data may be generated by management controller 152 and may be provided to management system 104 via out-of-band channel 172A through (i) transmission via a message, (ii) storing in a storage with subsequent retrieval by management system 104, (iii) a publish-subscribe system where management system 104 subscribes to updates from management controller 152 thereby causing a copy of the request for system data to be propagated to management system 104, and/or (iv) other processes. By providing the request for system data to management system 104, management system 104 may provide additional services for data processing system 102A.

Upon obtaining the request for system data, management system 104 may use device identifiers of data processing system 102A and/or management controller 152 in order to identify and package requested system data (e.g., by querying the backup database using the identifier(s)). Alternatively, if management controller 152 does not provide the request for system data, management system 104 may identify and push a system data package to management controller 152 automatically (e.g., after registering data processing system 102A as a trusted device, via the notification at interaction 208).

The system data may include, for example, critical data such as a private key of a public private key pair for data processing system 102A, certificates, basic input output system (BIOS) configuration data, and/or any other data structures necessary to repair operation of data processing system 102A. For example, other data structures may include data stored by data processing system 102A prior to the hardware event that may have become unusable by data processing system 102A after the hardware event.

At interaction 212, the system data may be provided (e.g., in a packaged form) to management controller 152 by management system 104. For example, the system data may be provided to management controller 152 via out-of-band channel 172A through (i) transmission via a message, (ii) storing in a storage with subsequent retrieval by management controller 152, (iii) a publish-subscribe system where management controller 152 subscribes to updates from management system 104 thereby causing a copy of the system data to be propagated to management controller 152, and/or (iv) other processes. By providing the system data to management controller 152, management controller 152 may perform an update process to mitigate the impairment of the operation of hardware resources 150.

Management controller 152 may initiate system update process 214 based on the system data. System update process 214 may include restoring the system data to its appropriate locations, deleting outdated portions of the system data, and/or other actions. For example, portions of the system data may be restored to local storage of management controller 152, local storage of a TPM of data processing system 102A, and/or other storage locations.

Portions of system update process 214 may be performed by management controller 152 independently from and/or in conjunction with hardware resources 150 (e.g., via communications across sideband channel 174A). To do so, management controller 152 may manage power to portions of hardware resources 150. The portions of hardware resources 150 may include, for example, storage components of hardware resources 150. For example, the system data may include encryption keys (e.g., public private encryption key pairs) that may be restored to the TPM.

System update process 214 may include performing a startup process (e.g., booting, automatically by management controller 152 and/or by the service technician) for data processing system 102A using the restored system data. For example, during the startup process, computer instructions for various software applications may be validated using images, keys, and/or other data structures stored in various repositories managed in part using a TPM of data processing system 102A (e.g., which may verify the content of the repositories, and limit use of secrets/other data structures depending on the extent to which the repositories and/or other data structures may be validated such as through hash matching). During the startup process, hardware resources 150 may be initialized and may become operable (e.g., indicated by the solid line descending from hardware resources 150 after system update process 214).

System update process 214 may include obtaining a notification. For example, management controller 152 may monitor system update process 214 and may generate the notification based on its own activity and/or that of hardware resources 150. The notification may indicate an outcome of system update process 214 and may include an acknowledgement of update process completion, any errors encountered, etc.

At interaction 216, the notification may be provided to management system 104 by management controller 152. For example, the notification may be provided to management system 104 via out-of-band channel 172A through (i) transmission via a message, (ii) storing in a storage with subsequent retrieval by management system 104, (iii) a publish-subscribe system where management system 104 subscribes to updates from management controller 152 thereby causing a copy of the notification to be propagated to management system 104, and/or (iv) other processes. Upon obtaining the notification, management system 104 may provide updates, for example, to a management console that may be monitored by management entities of data processing system 102A.

System update process 214 may complete when operation of hardware resources 150 are under management of a management entity and/or expected operation of hardware resources 150 is restored. Following the completion of system update process 214, data processing system 102A may be able to provide desired computer-implemented services.

Thus, as shown in the example of FIG. 2A, managing system data for a data processing system may include restoring system data that has been lost or made inaccessible to the data processing system from backup via out-of-band methods. Similarly, managing the system data may also include obtaining active (e.g., newly generated) system data in the event that at least a portion of the system data has expired.

Turning to FIG. 2B, a second interaction diagram in accordance with an embodiment is shown. The second interaction diagram may illustrate processes and interactions that may occur when updating (e.g., replacing) system data of a data processing system. Over time, secrets (e.g., encryption keys) stored securely within a TPM of the data processing system may expire and become unusable by data processing system 102A, which may cause a hardware event for the data processing system. As discussed, functionality of data processing system 102A may rely on usable cryptographic data; therefore, the expired secrets may impair and/or prevent operation of hardware resources 150 of data processing system 102A.

The expiration of an encryption key (e.g., the hardware event) may be identified by management controller 152 of data processing system 102A and/or by other entities. For example, management controller 152 may identify an expiration date of a certificate associated with the encryption key and/or a certificate authority (e.g., that issued the certificate) may notify a management entity of data processing system 102A (e.g., management system 104) that the encryption key has expired.

Once the occurrence of the hardware event is identified, management system 104 may obtain a notification of expiry. The notification of expiry may include identifying information for data processing system 102A, management controller 152, and/or the encryption key. The notification of expiry may be obtained from management controller 152 (e.g., shown at interaction 252, interaction 252 being optional as indicated by the dashed arrow) and/or from other entities (not shown).

For example, at interaction 252, management controller 152 may generate and provide the notification of expiry to management system 104 via out-of-band channel 172A through (i) transmission via a message, (ii) storing in a storage with subsequent retrieval by management system 104, (iii) a publish-subscribe system where management system 104 subscribes to updates from management controller 152 thereby causing a copy of the notification of expiry to be propagated to management system 104, and/or (iv) other processes. Upon obtaining the notification of expiry, management system 104 may provide encryption key renewal services.

To provide the services, management system 104 may initiate key generation process 254. Key generation process 254 may be performed by management system 104 and/or by a third party (e.g., as a service). For example, a certificate authority may obtain a request from management system 104 to generate a new encryption key for use by data processing system 102A. In response to the request, management system 104 may obtain an updated encryption key and certificate for data processing system 102A (e.g., from the third-party service).

To deploy newly generated keys to appropriate devices, management system 104 may initiate deployment process 256. During deployment process 256, management system 104 may obtain (e.g., generate) an update data package for data processing system 102A. The update data package may include the new encryption key, the certificate, instructions for data storage, and/or other information. The update data package my include a signed data structure, the signature being verifiable by management controller 152.

At interaction 258, the update data package may be provided to management controller 152 by management system 104. For example, the update data package may be provided to management controller 152 via out-of-band channel 172A through (i) transmission via a message, (ii) storing in a storage with subsequent retrieval by management controller 152, (iii) a publish-subscribe system where management controller 152 subscribes to updates from management system 104 thereby causing a copy of the update data package to be propagated to management controller 152, and/or (iv) other processes. By providing the update data package to management controller 152, management controller 152 may perform an update process to mitigate the impairment of the operation of hardware resources 150 caused by the expired encryption key.

Upon obtaining and validating the update data package, management controller 152 may perform system update process 260. System update process 260 may be similar to system update process 214 of FIG. 2A. For example, during system update process 260, management controller 152 may execute the instructions for data storage in order to restore data included in the update data package to data processing system 102A. For example, the new encryption key may be stored in TPM (e.g., replacing the expired encryption key). System update process 260 may include, for example, (i) performing a startup process using the replaced encryption key (e.g., to restore expected operation of hardware resources 150), and/or (ii) obtaining (e.g., generating) an acknowledgement indicating the encryption key has been appropriately stored and is usable by data processing system 102A.

At interaction 262, the acknowledgement may be provided to management system 104 by management controller 152. For example, the acknowledgement may be provided to management system 104 via out-of-band channel 172A through (i) transmission via a message, (ii) storing in a storage with subsequent retrieval by management system 104, (iii) a publish-subscribe system where management system 104 subscribes to updates from management controller 152 thereby causing a copy of the acknowledgement to be propagated to management system 104, and/or (iv) other processes. Upon obtaining the acknowledgement, management system 104 may update a management console that may be monitored by management entities of data processing system 102A.

As shown in the example of FIG. 2B, system data (e.g., encryption keys) that has become unusable by a data processing system may be restored (e.g., new encryption keys may be provided to the data processing system) via out-of-band methods.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2B may perform various methods to manage system data for data processing systems using out-of-band methods. Out-of-band components of the data processing system may respond to hardware independently from a management entity of the data processing system and/or when the data processing system is powered off (or in a low-powered state). The out-of-band channels may serve as a secure method of communication with remote systems that may facilitate recovery of the system data. By doing so, the system data may be restored to and/or made usable by the data processing system without the need for modifying software of the data processing system (e.g., re-installing the management entity and/or other software applications that may use the system data).

Turning to FIG. 3, a method that may be performed by the components of the system of FIGS. 1A-2B is illustrated. In the diagrams discussed below and shown in FIG. 3, any of the operations may be repeated, performed in different orders, and/or performed in parallel with or in a partially overlapping in time manner with other operations. The method described with respect to FIG. 3 may be performed by a data processing system (e.g., data processing system 102A) and/or another device.

At operation 302, an identification of an occurrence of a hardware event for a data processing system may be made. The identification may be made by (i) obtaining a message (e.g., an error message generated due to the hardware event, a notice of expiration of encryption keys, user input that may indicate occurrence of the hardware event), (ii) monitoring activity of hardware resources of the data processing system to identify a change (e.g., impairment) in their operation, and/or (iii) by other methods.

The hardware event may include modification of a component of the hardware resources. For example, in a first part of the hardware event, the component may be replaced (e.g., during servicing). The modification may be identified, for example, by a management controller of the data processing system by (i) snooping activity of the hardware resources (e.g., during a boot process for the data processing system), (ii) obtaining (e.g., fetching, receiving, via a sideband channel) a message regarding a secure component validation of the data processing system (e.g., during the boot process), and/or (iii) reading the content of the message (e.g., the content indicating that the secure component validation has failed). For example, the message may indicate that components of a current hardware loadout do not match components identified in an ownership voucher for the data processing system that was obtained prior to the hardware event (a “prior ownership voucher”).

In a second part of the hardware event, an updated ownership voucher for the data processing system may be established with the remote system. For example, ownership vouchers for the data processing system may be managed by the remote system. Therefore, when the component is modified (e.g., by a service technician), information reflecting the modification (e.g., a new component identifier) may be provided to the remote system (e.g., by the service technician and/or another entity authorized to update the ownership voucher) in order to establish the updated ownership voucher.

The occurrence of the hardware event may impair operation of hardware resources of the data processing system. For example, the hardware resources may become unpowered, remain unpowered, and/or have limited functionality. The impairment may limit ability of the data processing system to provide desired computer-implemented services.

At operation 304, based on the identification, a request for reprovisioning of the data processing system may be provided. The request for reprovisioning may be provided using methods similar to those described with respect to FIG. 2A (e.g., interaction 204) and/or by other methods. For example, the management controller may generate and provide the request for reprovisioning to a remote system (e.g., management system 104) via a secure out-of-band channel.

The request may be generated (e.g., by the management controller) based on and/or in response to an inability to locate a usable encryption key previously stored by the data processing system (e.g., the encryption key may be expired and/or access to the encryption key may be lost due to the modification of the hardware component). To generate the request, the management controller may, for example, read data from storage and/or snoop activity of the hardware resources to obtain a portion the information included in the request for reprovisioning. The request for reprovisioning may include an identifier for the modified component. For example, if the component was replaced as part of the hardware event, then the identifier for the replaced component may differ from that expected by the remote system (e.g., the identifier for the replaced component may not be reflected by the prior ownership voucher).

The remote system may facilitate reprovisioning of the data processing system by registering the data processing system as a trusted entity using the identifier for the modified component. Refer to the discussion of FIG. 2A for more details regarding reprovisioning processes.

At operation 306, a response to the request for reprovisioning may be obtained. The response may be obtained using methods similar to those described with respect to FIG. 2A (e.g., interaction 206) and/or by other methods. For example, the management controller may obtain the response from the remote system via the out-of-band channel. If the reprovisioning has been successful, then the response may include an updated (e.g., replacement) ownership voucher and/or a notification indicating that the reprovisioning has been successful (e.g., that the remote system has registered the data processing system has a trusted device).

At operation 308, based on the response to the request for reprovisioning, system data for the data processing system may be obtained. The system data may be obtained using methods similar to those described with respect to FIGS. 2A-2B (e.g., interactions 212, 258). For example, the management controller may request the system data from the remote system, or the remote system may automatically push the system data to the data processing system (e.g., via the management controller). The system data may be usable to manage the hardware event. For example, the system data may include a replacement encryption key (e.g., from backup and/or newly generated) necessary to restore expected operation to the hardware resources.

At operation 310, an update process may be performed in order to mitigate the impairment of the operation of the hardware resources. The update process may be performed using methods similar to those described with respect to FIGS. 2A-2B (e.g., system update processes 214, 260) and/or by other methods. The update process may include storing various portions of the system data according to instructions included as a portion of the system data. For example, the update process may be initiated and/or managed by the management controller, and the management controller may execute actions according to instructions. The management controller may provide the replacement encryption key via a sideband channel for storage in a TPM of the data processing system.

Performing the update process may include obtaining updated hardware resources. The updated hardware resources may be obtained by (i) storing the system data in one or more storage locations of the data processing system, and/or (ii) performing a startup process using the system data to initialize operation of the hardware resources. For more information regarding startup processes, refer to the discussion of FIGS. 2A-2B.

Performing the update process may further include providing a notification indicating an outcome of the update process. The notification may be provided via data transmission, by the management controller via the out-of-band channel to the remote system.

The occurrence of the hardware event may be managed while the hardware resources are inoperable. For example, any portions of operations 302-310 may be performed while a portion of the hardware resources are unpowered, by virtue of some components (e.g., the management controller) of the data processing system (i) being powered independently from hardware resources, and/or (ii) managing power distribution to portions of the hardware resources as needed. Refer to FIG. 1B for more information regarding components of the data processing system.

At operation 312, a computer-implemented service may be provided using the updated hardware resources. The computer-implemented service may be provided by completing the startup process for the data processing system using portions of the system data. Once the startup process is complete, the hardware resources may host software applications and/or perform various process that may facilitate the provision of the computer-implemented service. For example, the hardware resources may, in part, provide the computer-implemented service by executing instructions provided via the hosted software.

The method may end following operation 312.

As illustrated above, embodiments disclosed herein may provide systems and methods usable to manage hardware events for a data processing system. To manage the hardware events, system data for the data processing system may be obtained from remote systems via secure out-of-band channels. Out-of-band components of the data processing systems may initiate and/or perform a system update process using the system data while in-band components are subject to impaired operation (e.g., in-band components may be inoperable due to a hardware event).

The occurrences of the hardware events may be managed, at least in part, automatically over secure out-of-band channels, reducing the likelihood of service disruptions, and/or security issues that may arise while managing the hardware events. Accordingly, the disclosed process provides for both an embodiment in computing technology and an improved method for managing the security of data processing systems.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations.

System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-408 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like.

More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets.

Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system, the method comprising:
making, by a management controller of the data processing system, an identification of an occurrence of a hardware event for the data processing system that impairs operation of hardware resources of the data processing system; and
based on the identification:
providing, by the management controller and via an out-of-band channel and to a remote system, a request for reprovisioning of the data processing system,
obtaining, by the management controller and via the out-of-band channel and from the remote system, a response to the request for reprovisioning, and
based on the response to the request for reprovisioning:
obtaining, by the management controller and via the out-of-band channel and from the remote system, system data for the data processing system, the system data being usable to manage the hardware event;
performing, by the data processing system, an update process using the system data in order to mitigate the impairment of the operation of the hardware resources to obtain updated hardware resources; and
providing, by the data processing system, a computer-implemented service using the updated hardware resources.

2. The method of claim 1, wherein the hardware event comprises modification of a component of the hardware resources.

3. The method of claim 2, wherein the modification causes an encryption key previously stored by the data processing system to become unusable by the data processing system.

4. The method of claim 3, wherein the request for reprovisioning comprises an identifier for the component of the hardware resources, the component having been replaced as a first part of the hardware event and the replacement of the component causing the hardware resources to differ from that expected by the remote system.

5. The method of claim 4, wherein the reprovisioning comprises registering the data processing system using the identifier for the component, and an updated ownership voucher established with the remote system as a second part of the hardware event.

6. The method of claim 5, wherein the system data comprises the encryption key.

7. The method of claim 6, wherein performing the update process comprises:
providing, by the management controller and via a sideband channel, the encryption key for storage in a trusted platform module of the data processing system.

8. The method of claim 7, wherein performing the update process further comprises:
providing, by the management controller and via the out-of-band channel and to the remote system, a notification indicating an outcome of the update process.

9. The method of claim 1, wherein the data processing system comprises a network module adapted to separately advertise network endpoints for the management controller and the hardware resources, the network endpoints being usable by remote systems to address communications to the hardware resources and the management controller.

10. The method of claim 9, wherein the out-of-band channel runs through the network module and an in-band channel that services the hardware resources also runs through the network module.

11. The method of claim 9, wherein the management controller and the network module are on separate power domains from the hardware resources so that the management controller and the network module are operable while the hardware resources are inoperable.

12. The method of claim 11, wherein the occurrence of the hardware event is managed while the hardware resources are inoperable due to being unpowered.

13. A non-transitory machine-readable medium having instructions stored therein, which when executed by a processor, cause the processor to perform operations for managing a data processing system, the operations comprising:
making, by a management controller of the data processing system, an identification of an occurrence of a hardware event for the data processing system that impairs operation of hardware resources of the data processing system; and
based on the identification:
providing, by the management controller and via an out-of-band channel and to a remote system, a request for reprovisioning of the data processing system,
obtaining, by the management controller and via the out-of-band channel and from the remote system, a response to the request for reprovisioning, and
based on the response to the request for reprovisioning:
obtaining, by the management controller and via the out-of-band channel and from the remote system, system data for the data processing system, the system data being usable to manage the hardware event;
performing, by the data processing system, an update process using the system data in order to mitigate the impairment of the operation of the hardware resources to obtain updated hardware resources; and
providing, by the data processing system, a computer-implemented service using the updated hardware resources.

14. The non-transitory machine-readable medium of claim 13, wherein the hardware event comprises modification of a component of the hardware resources.

15. The non-transitory machine-readable medium of claim 14, wherein the modification causes an encryption key previously stored by the data processing system to become unusable by the data processing system.

16. The non-transitory machine-readable medium of claim 15, wherein the request for reprovisioning comprises an identifier for the component of the hardware resources, the component having been replaced as a first part of the hardware event and the replacement of the component causing the hardware resources to differ from that expected by the remote system.

17. A data processing system, comprising:
a processor; and
a memory coupled to the processor to store instructions, which when executed by the processor, cause the processor to perform operations for managing the data processing system, the operations comprising:
making, by a management controller of the data processing system, an identification of an occurrence of a hardware event for the data processing system that impairs operation of hardware resources of the data processing system, and
based on the identification:
providing, by the management controller and via an out-of-band channel and to a remote system, a request for reprovisioning of the data processing system;
obtaining, by the management controller and via the out-of-band channel and from the remote system, a response to the request for reprovisioning; and
based on the response to the request for reprovisioning:
obtaining, by the management controller and via the out-of-band channel and from the remote system, system data for the data processing system, the system data being usable to manage the hardware event,
performing, by the data processing system, an update process using the system data in order to mitigate the impairment of the operation of the hardware resources to obtain updated hardware resources, and
providing, by the data processing system, a computer-implemented service using the updated hardware resources.

18. The data processing system of claim 17, wherein the hardware event comprises modification of a component of the hardware resources.

19. The data processing system of claim 18, wherein the modification causes an encryption key previously stored by the data processing system to become unusable by the data processing system.

20. The data processing system of claim 19, wherein the request for reprovisioning comprises an identifier for the component of the hardware resources, the component having been replaced as a first part of the hardware event and the replacement of the component causing the hardware resources to differ from that expected by the remote system.
